(19) United States
(12) Patent Application Publication
(10) Pub. No.: US 2016/0360710 A1
(43) Pub. Date: Dec. 15, 2016

(54) POT-TRAY SECURING MEMBER AND METHOD

(71) Applicant: Landmark Plastic Corporation, Akron, OH (US)

(72) Inventors: Robert G. MERZWEILER, Akron, OH (US); Steven P. MERZWEILER, Akron, OH (US)

(21) Appl. No.: 15/179,191

(22) Filed: Jun. 10, 2016

Related U.S. Application Data
(60) Provisional application No. 62/174,892, filed on Jun. 12, 2015.

(51) Int. Cl. A01G 9/02; A01G 1/00

(52) U.S. Cl. CPC A01G 9/028; A01G 1/001

(57) ABSTRACT

The invention includes a pot-tray securing member configured to fixedly retain a horticultural pot within a tray, and methods of securing a pot within a tray using the pot-tray member. In particular embodiments, the pot-tray securing member includes a pot-engaging portion configured to engage the pot arranged within the tray on a side of the pot opposite the tray. In such embodiments, the pot-tray securing member also includes a tray-anchoring portion configured to fix the securing member to the tray, the tray configured to receive and store the pot, where the tray-anchoring portion is operably connected to the pot-engaging portion of the securing member.

### CROSS REFERENCE TO RELATED APPLICATION

This application claims priority to, and the benefit of, U.S. Provisional Patent Application Ser. No. 62/174,892, filed Jun. 12, 2015, with the U.S. Patent Office, which is hereby incorporated by reference.

### BACKGROUND OF THE INVENTION

Field of the Invention

The present disclosure relates generally to horticultural pots (containers) and trays for receiving and storing one or more pots, and a locking member for fixing one or more pots into the tray. A horticultural pot includes a pot configured to grow seedlings or retain plants, trees, or the like.

Description of the Related Art

Pots are generally used to grow, store, and/or transport a variety of plants or the like. Trays are used to receive and store pots for improved storage and/or transportation There is a need for a mechanism that allows for improved securement of one or multiple pots within a tray.

### SUMMARY OF THE INVENTION

Particular embodiments of the invention include a pot-tray securing member, a pot-tray system including the pot-tray securing member, and a method of securing a pot within a tray using the pot-tray securing member, in accordance with different embodiments thereof.

In particular embodiments, the pot-tray securing member, configured to secure (fixedly retain) a horticultural pot within a tray, comprises a pot-engaging portion configured to engage the pot arranged within the tray on a side of the pot opposite the tray, and a tray-anchoring portion configured to fix the securing member to the tray, the tray configured to receive and store the pot, where the tray-anchoring portion is operably connected to the pot-engaging portion of the securing member.

In particular embodiments, the pot-tray system comprises a pot having a storage receptacle, one or more sidewalls together extending around the storage receptacle, an end wall extending from the one or more sidewalls and forming a bottom of the storage receptacle, an open end arranged opposite the end wall and having an opening configured to receive matter to be retained within the storage receptacle, and a rim arranged along one or more sidewalls at the open end and extending at least partially around the opening. Such embodiments of the pot-tray system also include a tray configured to receive the pot and the pot-tray securing member described above.

In particular embodiments, the method of securing (fixedly retaining) a pot within a tray comprises arranging a pot within a tray. In such embodiments, the pot has a storage receptacle, one or more sidewalls together extending around the storage receptacle, an end wall extending from the one or more sidewalls and forming a bottom of the storage receptacle, an open end arranged opposite the end wall and having an opening configured to receive matter to be retained within the storage receptacle, and a rim arranged along one or more sidewalls at the open end and extending at least partially around the opening. In such embodiments, the tray is configured to receive the pot. Such embodiments of such methods also includes securing the pot to the tray using a pot-tray securing member, the pot-tray securing member comprising the pot-tray securing member described above, where in securing the pot to the tray, the pot-engaging portion engages the pot and the tray-anchoring portion is fixed to the tray.

The foregoing and other objects, features, and advantages of the invention will be apparent from the following more detailed descriptions of particular embodiments of the invention, as illustrated in the accompanying drawings wherein like reference numbers represent like parts of the invention.

### DETAILED DESCRIPTION OF THE DRAWINGS

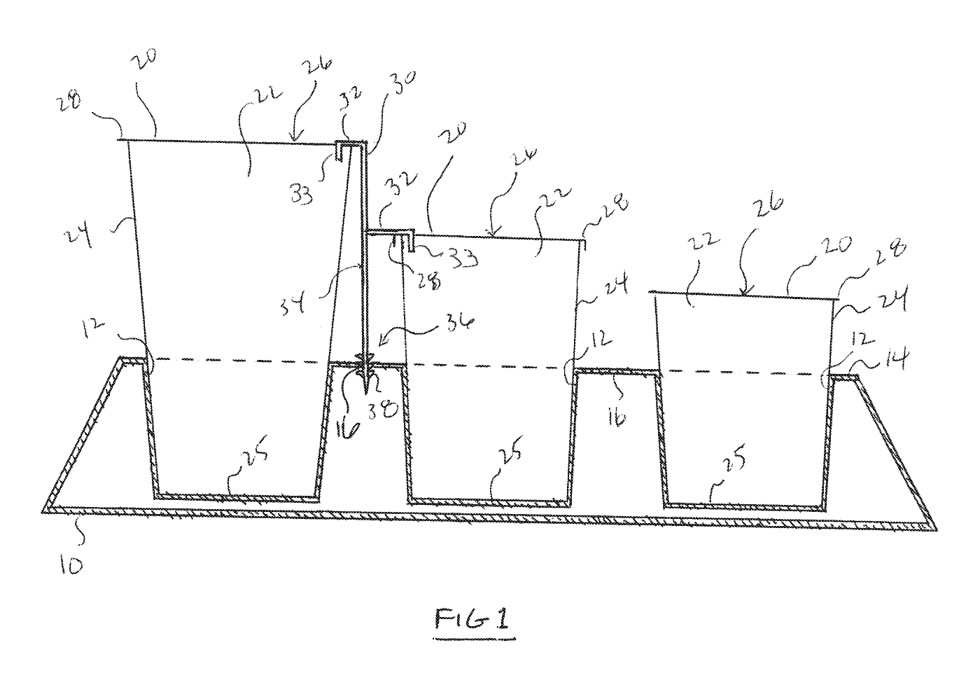

FIG. 1 is a side sectional view of a tray having arranged therein a plurality of pots, two of which are secured in the tray with a pot-tray securing member, in accordance with an exemplary embodiment of the invention.

FIG. 2 is a top view of a tray having arranged therein a plurality of pots, four of which are secured in the tray with a pot-tray securing member, in accordance with an exemplary embodiment of the invention.

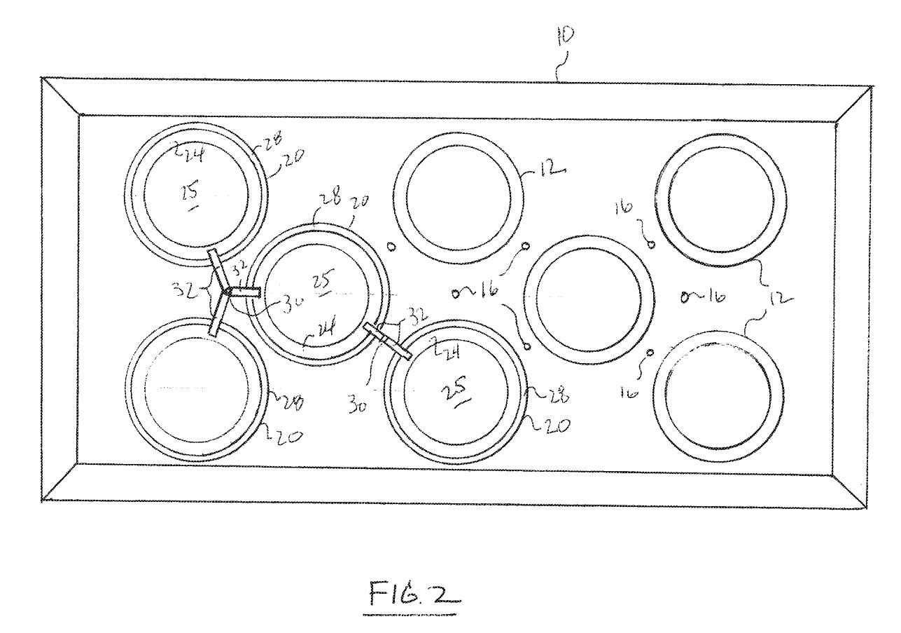

FIG. 3 is a side view of a pot-tray securing member having pot-engaging portions that may be added, removed, or moved as desired, in accordance with an exemplary embodiment of the invention.

FIG. 4 is a partial side view of a pot-tray securing member showing a tray-anchoring portion of the securing member, the tray-anchoring member having a plurality of protrusions for resisting the removal of the pot-tray securing member from a tray, in accordance with another exemplary embodiment of the invention.

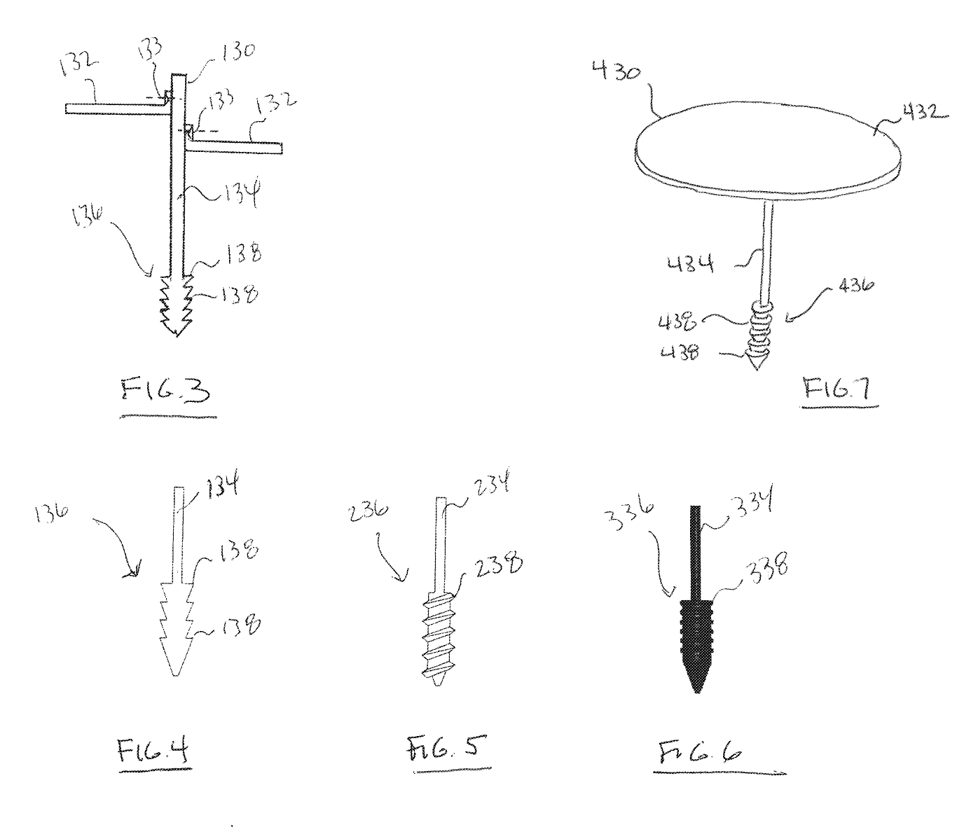

FIG. 5 is a partial side view of a pot-tray securing member showing a tray-anchoring portion of the securing member, the tray-anchoring member having a single protrusion extending helically along a length of the tray-anchoring member for resisting the removal of the pot-tray securing member from a tray, in accordance with another exemplary embodiment of the invention.

FIG. 6 is a partial side view of a pot-tray securing member showing a tray-anchoring portion of the securing member, the tray-anchoring member having a plurality of protrusions comprising rings or annular ribs for resisting the removal of the pot-tray securing member from a tray, in accordance with another exemplary embodiment of the invention.

FIG. 7 is a perspective top view of a pot-tray securing member having a pot-engaging portion configured to engage multiple pots, in accordance with another exemplary embodiment of the invention.

### DETAILED DESCRIPTION OF PARTICULAR EMBODIMENTS

Particular embodiments of the invention include a pot-tray securing member, a pot-tray system including the pot-tray securing member, and a method of securing a horticultural pot within a tray using the pot-tray securing member, in accordance with different embodiments thereof.

It is appreciated that certain retailers desire to have multiple pots sold as a single sellable unit. A horticultural pot refers to a container configured to retain soil, soil-less media, amendments, or any combination of the like to grow seedlings, plants, trees and the like within the container. A horticultural pot may comprise any such container, including without limitation a nursery can, pan, planter, or flower pot. A tray is used to retain a group of pots for ease of planting, growing, watering, and/or transporting the group of pots. The pot-tray securing member described herein locks, holds and unitizes one or a plurality of pots within a tray. When pots are properly secured to a tray, the pot(s) will remain properly positioned within the tray as the pot-tray assembly is shipped, and any such pot is less-likely to be improperly removed or pilfered from the tray.

With regard to the method of securing (that is, fixedly retaining) a pot within a tray, particular embodiments of such method includes arranging a pot within a tray. It is appreciated that the pot may comprise any horticultural pot used to grow seedlings or otherwise to retain soil (actual or artificial substitute) and any one or more seedlings, plants, trees, or the like. For example, in an exemplary embodiment, the pot has a storage receptacle, one or more sidewalls together extending around the storage receptacle, an end wall extending from the one or more sidewalls and forming a bottom of the storage receptacle, an open end arranged opposite the end wall and having an opening configured to receive matter to be retained within the storage receptacle, and a rim arranged along one or more sidewalls at the open end and extending at least partially around the opening. The tray is configured to receive the pot.

Such particular embodiments of the method also include securing the pot to the tray using a pot-tray securing member. As discussed further below, any of a variety of pot-tray securing members may be employed, including any embodiment of the pot-tray securing member discussed herein. In exemplary embodiments, the pot-tray securing member comprises a pot-engaging portion configured to engage the pot arranged within the tray on a side of the pot opposite the tray, and a tray-anchoring portion configured to fix the securing member to the tray, the tray being configured to receive and store the pot. In such exemplary embodiments, the tray-anchoring portion is operably connected to the pot-engaging portion of the securing member. In securing the pot to the tray, the pot-engaging portion engages the pot and the tray-anchoring portion is fixed to the tray.

It is contemplated that the tray-anchoring portion may be secured or fixed to the tray in any desired manner using any known device and method for fixing one object to another. In particular embodiments, for example, in fixing the tray-anchoring portion to the tray, the tray-anchoring portion is inserted into an aperture within the tray such that the one or more protrusions resist removal of the pot-tray securing member from the aperture by mechanical interference. In such instances, the attachment can be temporary, such as being removable and re-attachable, or generally permanent where removal sufficiently damages the securing member or the tray to render reattachment in the same manner generally unachievable. In other exemplary embodiments, a permanent attachment may be achieved using any desired method, which includes bonding the tray-anchoring portion to the tray, such as by use of one or more welds or adhesives, for example. Welds may be accomplished using any known technique, including solvent welding, sonic welding, vibration welding and or spin welding.

It is also contemplated that in configuring the pot-engaging portion to engage a rim of the pot, the pot-engaging portion may be configured to engage any portion of the pot arranged on a side of the pot opposite the tray. In specific embodiments, the pot-engaging portion is configured to engage a top or rim of the pot. As noted herein, the rim is arranged along one or more sidewalls an open end of the pot and extending at least partially around an opening arranged at the open end of the pot, the opening configured to receive matter to be retained within the storage receptacle and arranged opposite an end wall extending from the one or more sidewalls, the end wall forming a bottom of the storage receptacle and the one or more sidewalls together extending around the storage receptacle. In such embodiments, where in engaging the pot to secure the pot within the tray, the pot-engaging portion engages the rim of the pot.

It is appreciated that any pot-tray securing member may secure one pot or a plurality of pots to a tray. In particular variations of the methods described above, the pot-tray securing member further comprises one or more additional pot-engaging portions operably connected to the tray-anchoring portion, each of the one or more additional pot-engaging portions configured to engage a different, additional pot arranged within the tray on a side of the pot opposite the tray, where in securing the pot within the tray, a plurality of pots are secured within the tray as the pot-tray securing member engages the plurality of pots. It is appreciated that in other embodiments, any pot-engaging portion may configured to engage a single pot or a plurality of pots (that is, two or more pots).

As for the pot-engaging portion of the pot-tray securing member, it is appreciated that the pot-engaging portion may comprise any form configured to engage a pot or a plurality of pots as desired to secure the pot or pots between the pot-engaging portion and the tray. For example, in particular embodiments, the pot-engaging portion is an elongate structure, such as a bar, rod, pipe, or plate, for example, extending in a direction generally transverse to a depthwise direction of the pot, or in a direction extending across the opening of the pot, which may be a direction transverse to a lengthwise direction of the tray-anchoring portion (or generally perpendicular thereto, in particular instances). It is further contemplated that the pot-engaging portion may be an elongate member having a cross-section shape of any form, including any round, rectangular, or square form, for example, or any other shape to generally match the profile of the pot or pot rim. The size of the pot-engaging portion may be fixed or static, or may be adjustable, such as having an adjustable length, for example.

In other variations, an additional extension of the pot-engaging portion is directed downward toward a bottom of the pot is provided. In certain instances of such embodiments, it can be said that the pot-engaging portion of the pot-tray securing member comprises a hook-shaped member. By having the additional extension or hook-shaped member, the pot-engaging portion can better resist any lateral or transverse forces and therefore secure the pot within the tray. That being said, by generally engaging the pot to secure the pot within the tray, the pot-engaging member resists forces acting at least partially in a vertical direction or in a direction normal from the tray, as opposed to a direction transversely across the tray.

It is contemplated that the pot-engaging portion may be selectively removable relative the tray-anchoring portion, so to adapted to different height pots, and in accordance with certain embodiments of the methods, is selectively moved to engage the pot in securing the pot to the tray. Removability facilitates the addition and/or repositioning of any pot-engaging portion. Removability and attachment may be accomplished using any known structure and any known manner of adapting an object to be removable and attachable to another object. For example, fasteners, clamps, pins, or any other mechanical device(s) or feature(s) for securing the pot-engaging portion to the pot-tray securing member may be employed to permit removal and repositioning of the pot-engaging portion along the pot-tray securing member.

As for the tray-anchoring portion of the pot-tray securing member, it is appreciated that the tray-anchoring portion may comprise any form configured to secure the pot-tray securing member to the tray and resist removal of the tray-anchoring portion from the tray. For example, in particular embodiments where the tray-anchoring portion is inserted into an aperture within a tray, the tray-anchoring portion of the pot-tray securing member comprises an elongate member having one or more protrusions extending outwardly from the elongate member, the pot-tray portion being configured to be inserted into an aperture within the tray. It is appreciated that the one or more protrusions may comprise any desired protrusion configured to resist the removal of the tray-anchoring portion from the tray, and more specifically from the aperture in the tray. In certain instances, the one or more protrusions of the pot-tray securing member provide opposing cross-sectional protrusions extending outwardly from opposing sides of a cross-section of the elongate member. These opposing cross-sectional protrusions may be formed from a single protrusion arranged along the tray-anchoring portion, such as when the single protrusion is a helix (that is, when it extends helically around and along the elongate member or tray-anchoring portion), for example. This helix is also referred to as a thread. The opposing cross-sectional protrusions may instead be formed by a plurality of separate protrusions. For example, the plurality of protrusions may form a saw tooth pattern of protrusions. Also, it is contemplated that the one or more protrusions may be retractable, such as by using a cam or one or more springs, for example, which can permit removability of the pot-tray securing member from a tray without damaging any structure thereof.

To permit the pot-tray securing member to adapt to different pot heights and/or to adapt to different tray designs where the distance between the open end of the pot and the tray vary, in addition to or in the alternative to the pot-engaging members being movable, the pot-tray securing member may also have an adjustable height or length. For example, segments may be added or removed from the tray-anchoring portion to increase or decrease the elongate length of the tray-anchoring portion or more generally of the pot-tray securing member. Additionally or alternatively, the length of the tray-anchoring member may be retractable/telescopic to adjust its length as desired.

In summary, the pot-tray securing member can be designed to secure any desired pot, including any round, square, hexagonal, oblong or any other shaped pot to a tray. The pot-tray securing member may also secure any sized pot, of any width, perimeter, or height. It is appreciated that the pot-tray securing member may be formed of any desired material in accordance with any desired manufacturing process. For example, the pot-tray securing member may be formed of plastic, ceramic, terra cotta, steel, aluminum, wood, and/or copper. When made out of plastic, the pot-tray securing member can be made using any know molding process, including a thermoforming, injection molding, compression molding, transfer molding, or blow molding manufacturing process, for example. Finally, it is appreciated that the pot-tray securing member can be added at any time, such as before soil is added to the pot, when any plant is growing, before the pots and tray are shipped to the retailer, or after they reach the retailer or any other time during the time the pot is in a tray.

Particular embodiments of the methods and apparatus discussed above will now be described in further detail below in association with the figures filed herewith providing exemplary embodiments of apparatus for performing particular embodiments of the methods discussed above.

With reference to an exemplary embodiment shown in FIG. 1, a pot-tray system including a tray 10 having arranged therein a plurality of pots 20, two of which are secured in the tray with a pot-tray securing member 30. Each pot 20 has a storage receptacle 22, one or more sidewalls 24 together extending around the storage receptacle, an end wall 25 extending from the one or more sidewalls and forming a bottom of the storage receptacle, an open end arranged opposite the end wall and having an opening 26 configured to receive matter to be retained within the storage receptacle, and a rim 28 arranged along one or more sidewalls at the open end and extending at least partially around the opening. Tray 10 is configured to receive the pot. In the exemplary embodiment shown, the tray 10 includes a pot receptacle 12 shaped and sized for receiving each pot 20. The tray 10 also includes apertures 16 for receiving the pot-tray securing member 30. It is appreciated that, in lieu of providing any apertures, a self-piercing pot-tray securing member may be employed in embodiments where mechanical interference attachment is desired.

With continued reference to FIG. 1, the pot-tray securing member 30 includes a pot-engaging portion 32 configured to engage the pot 20 arranged within the tray 10 on a side of the pot opposite the tray. What this means is that the pot-engaging portion 32 may engage any surface that is located along the interior of the pot, including any interior surface of the sidewalls located within the storage receptacle 22, or any surface arranged along a top side of the rim since the purpose of the pot-engaging member arrange the pot between the pot-engaging portion and the tray. The pot-tray securing member 30 also includes a tray-anchoring portion 36 configured to fix the securing member 30 to the tray 10, the tray configured to receive and store the pot, where the tray-anchoring portion is operably connected to the pot-engaging portion of the securing member. It is appreciated that operable connection between the pot-engaging portion and the tray-anchoring portion may be accomplished by way of molding operation or by selective connection between the two portions, such as by use of fasteners or bonding, which includes welding or use of adhesives, for example.

In the exemplary embodiment shown in FIG. 1, the pot-engaging portion 32 of the pot-tray securing member 30 engages two pots 20 and the tray-anchoring portion 36 is fixed to the tray 10 to secure the two pot along the tray. More specifically, the pot-engaging portion 32 is configured to engage a top or rim 28 of the pot at an open end. To engage two pots, the pot-tray securing member 30 includes two pot-engaging portions 32 operably each connected to the tray-anchoring portion 36, where each of the pot-engaging portions is configured to engage a different pot 20 arranged along the tray 10 on a side of the pot opposite the tray. It is also noted that each pot-engaging portion 32 of the pot-tray securing member 30 comprises a hook-shaped member, where a downward extension 33 extends from an initial arm-like portion or extension.

With continued reference to FIG. 1, the tray-anchoring portion 36 of the pot-tray securing member 30 comprises an elongate member 34 having one or more protrusions 38 extending outwardly from the elongate member. The one or more protrusions 38 provide opposing cross-sectional protrusions extending outwardly from opposing sides of a cross-section of the elongate member. It is appreciated that the tray-anchoring portion 36 and the elongate member 34 thereof may have any desired shape or profile, which may be flat, tapered, or twisted, for example.

With reference now to another exemplary embodiment in FIG. 2, a top view is shown of a tray 10 having arranged therein a plurality of pots 20, four of which are secured in the tray with a pot-tray securing member. Specifically shown are two pot-tray securing members 30 each having a plurality of pot-engaging portions 32 such that each is configured to engage multiple, independent or separate pots 20. One pot-tray securing member 32 is configured to engage three pots 20 while the other is configured to engage two pots. It is contemplated that, in particular embodiments, pot-engaging portions 32 may be added to or removed from a pot-tray securing member to engage more or less pots. Also, the pot-engaging portions 32 may remain fixed relative to the pot-tray securing member or may rotate or pivot to better align itself to engage a desired pot. Also shown in FIG. 2 are apertures 16 arranged near pot-receiving receptacles 12 and configured to receive the tray-anchoring portion 36 of a pot-tray securing member 30. It is appreciated that the aperture within a plastic tray (into which the tray-anchoring portion is inserted in particular embodiments) can be formed by any desired process, including without limitation a matched metal trim die, steel rule die, burning, water jet, laser or any other desired method to cut plastic. Additionally, the aperture in the tray can be of any desired shape, such as circular, rectangular, square, oblong, hexagonal, cross or any other shape, which includes forming a slit. This aperture within the tray can also be of any desired size designed to properly operate in conjunction with the pot-tray securing member.

With reference now to another exemplary embodiment in FIG. 3, a side view of a pot-tray securing member 130 is shown having two pot-engaging portions 132 selectively movable/removable that may be selectively added, removed, or moved as desired. Fasteners 133 are employed to attach any desired pot-engaging portion 132 of any desired design or configuration in any desired location along pot-tray securing member 130. As noted elsewhere herein, such attachment of the pot-engaging members may accomplished using other mechanisms or features in lieu of fasteners.

FIGS. 4-6 show other exemplary embodiments of protrusions arranged along the tray-anchoring portion of a pot-tray securing member. In FIG. 4, tray-anchoring portion 136 includes a plurality of saw tooth-like protrusions 138 arranged along elongate member 134. In FIG. 5, tray-anchoring portion 236 includes a protrusion 238 comprising a helix extending helically along a length of the elongate member 234. In FIG. 6, tray-anchoring portion 336 includes a plurality of protrusions 338 comprising annular ribs or ridges arranged along length of elongate member 334. As noted elsewhere herein, it is appreciated that any other one or more protrusions of different design and/or configuration may be arranged along any tray-anchoring portion as desired.

With reference to FIG. 7, a pot-tray securing member 430 is shown having a pot-engaging portion 432 configured to engage a plurality of pots. It the present configuration, the pot-engaging portion 432 is configured to engage multiple pots of the same height or multiple pots where the rim of each is maintained at the substantially the same elevation. In the embodiment shown, the pot-engaging portion 432 is a round plate, although in other variations a plate of any shape may be employed, such as a square, rectangular, triangular, or oval shaped plate, for example. Also, the plate shown is planar, or, in other words, the plate has a planar pot-engaging surface. In other variations, a pot-engaging portion configured to engage multiple pots may be non-planar, such that pots of different heights or pots maintained at different elevations may be engaged by the single pot-engaging portion. Finally, the pot-engaging portion configured to engage multiple pots may remain fixed or integral or may be movable along the pot-tray securing member, so to be adjustable for the purpose of accommodating different pot elevations.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The terms “at least one” and “one or more” are used interchangeably. The term “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (i.e., not required) feature of the invention. Ranges that are described as being “between a and b” are inclusive of the values for “a” and “b” unless otherwise specified.

While this invention has been described with reference to particular embodiments thereof, it shall be understood that such description is by way of illustration only and should not be construed as limiting the scope of the claimed invention. Accordingly, the scope and content of the invention are to be defined only by the terms of the following claims. Furthermore, it is understood that the features of any specific embodiment discussed herein may be combined with one or more features of any one or more embodiments otherwise discussed or contemplated herein unless otherwise stated.

What is claimed is:

1. A pot-tray securing member configured to fixedly retain a horticultural pot within a tray, the securing member comprising:
a pot-engaging portion configured to engage the pot arranged within the tray on a side of the pot opposite the tray; and,
a tray-anchoring portion configured to fix the securing member to the tray, the tray configured to receive and store the pot, where the tray-anchoring portion is operably connected to the pot-engaging portion of the securing member.

2. The pot-tray securing member of claim 1, where the pot-engaging portion is configured to engage a rim of the pot, the rim arranged along one or more sidewalls an open end of the pot and extending at least partially around an opening arranged at the open end of the pot, the opening configured to receive matter to be retained within the storage receptacle and arranged opposite an end wall extending from the one or more sidewalls, the end wall forming a bottom of the storage receptacle and the one or more sidewalls together extending around the storage receptacle.

3. The pot-tray securing member of claim 1 further comprising: one or more additional pot-engaging portions operably connected to the tray-anchoring portion, each of the one or more additional pot-engaging portions configured to engage a different, additional pot arranged within the tray on a side of the pot opposite the tray.

4. The pot-tray securing member of claim 1, wherein the pot-engaging portion comprises a hook-shaped member.

5. The pot-tray securing member of claim 1, where the tray-anchoring portion comprises an elongate member having one or more protrusions extending outwardly from the elongate member.

6. The pot-tray securing member of claim 5, where the one or more protrusions provide opposing cross-sectional protrusions extending outwardly from opposing sides of a cross-section of the elongate member.

7. The pot-tray securing member of claim 6, where the one or more protrusions comprise a helix forming a protrusion extending helically along a length of the elongate member.

8. The pot-tray securing member of claim 1, where the pot-engaging portion is selectively removable relative the tray-anchoring portion.

9. A pot-tray system comprising:
a pot having a storage receptacle, one or more sidewalls together extending around the storage receptacle, an end wall extending from the one or more sidewalls and forming a bottom of the storage receptacle, an open end arranged opposite the end wall and having an opening configured to receive matter to be retained within the storage receptacle, and a rim arranged along one or more sidewalls at the open end and extending at least partially around the opening;
a tray configured to receive the pot; and,
a pot-tray securing member comprising:
a pot-engaging portion configured to engage the pot arranged within the tray on a side of the pot opposite the tray; and,
a tray-anchoring portion configured to fix the securing member to the tray, the tray configured to receive and store the pot, where the tray-anchoring portion is operably connected to the pot-engaging portion of the securing member.

10. The pot-tray system of claim 9, where the pot-engaging portion of the pot-tray securing member engages the pot and the tray-anchoring portion is fixed to the tray to secure the pot within the tray.

11. The pot-tray system of claim 9, where the pot-engaging portion is configured to engage a rim of the pot, the rim arranged along one or more sidewalls an open end of the pot and extending at least partially around an opening arranged at the open end of the pot, the opening configured to receive matter to be retained within the storage receptacle and arranged opposite an end wall extending from the one or more sidewalls, the end wall forming a bottom of the storage receptacle and the one or more sidewalls together extending around the storage receptacle.

12. A method of securing a pot within a tray, the method comprising:
arranging a pot within a tray,
the pot having a storage receptacle, one or more sidewalls together extending around the storage receptacle, an end wall extending from the one or more sidewalls and forming a bottom of the storage receptacle, an open end arranged opposite the end wall and having an opening configured to receive matter to be retained within the storage receptacle, and a rim arranged along one or more sidewalls at the open end and extending at least partially around the opening,
the tray configured to receive the pot; securing the pot to the tray using a pot-tray securing member, the pot-tray securing member comprising:
a pot-engaging portion configured to engage the pot arranged within the tray on a side of the pot opposite the tray; and,
a tray-anchoring portion configured to fix the securing member to the tray, the tray configured to receive and store the pot, where the tray-anchoring portion is operably connected to the pot-engaging portion of the securing member, where in securing the pot to the tray, the pot-engaging portion engages the pot and the tray-anchoring portion is fixed to the tray.

13. The method of claim 12, where in fixing the tray-anchoring portion to the tray, the tray-anchoring portion is inserted into an aperture within the tray such that the one or more protrusions resist removal of the pot-tray securing member from the aperture by mechanical interference.

14. The method of claim 12, where the pot-engaging portion is configured to engage a rim of the pot, the rim arranged along one or more sidewalls an open end of the pot and extending at least partially around an opening arranged at the open end of the pot, the opening configured to receive matter to be retained within the storage receptacle and arranged opposite an end wall extending from the one or more sidewalls, the end wall forming a bottom of the storage receptacle and the one or more sidewalls together extending around the storage receptacle, where in engaging the pot to secure the pot within the tray, the pot-engaging portion engages the rim of the pot.

15. The method of claim 12, where the pot-tray securing member further comprises:
one or more additional pot-engaging portions operably connected to the tray-anchoring portion, each of the one or more additional pot-engaging portions configured to engage a different, additional pot arranged within the tray on a side of the pot opposite the tray, where in securing the pot within the tray, a plurality of pots are secured within the tray as the pot-tray securing member engages the plurality of pots.

16. The method of claim 12, wherein the pot-engaging portion of the pot-tray securing member comprises a hook-shaped member.

17. The method of claim 12, where the tray-anchoring portion of the pot-tray securing member comprises an elongate member having one or more protrusions extending outwardly from the elongate member.

18. The method of claim 17, where the one or more protrusions of the pot-tray securing member provide opposing cross-sectional protrusions extending outwardly from opposing sides of a cross-section of the elongate member.

19. The method of claim 18, where the one or more protrusions of the pot-tray securing member comprise a helix forming a protrusion extending helically along a length of the elongate member.

20. The method of claim 12, where the pot-engaging portion is selectively removable relative the tray-anchoring portion, and is selectively moved to engage the pot in securing the pot to the tray.
